(19) United States
(12) Patent Application Publication
(10) Pub. No.: US 2026/0143174 A1
(43) Pub. Date: May 21, 2026

(54) VIDEO HARDWARE DECODER CIRCUIT AND A CONTROL METHOD AND A CONTROL SYSTEM FOR BIT STREAM PARSING ERROR DETECTION THEREIN

(71) Applicant: GLENFLY TECH CO., LTD. (SHANGHAI), Shanghai (CN)

(72) Inventors: Cong ZHU, Shanghai (CN); Wu HAO, Shanghai (CN); Jinjing LI, Shanghai (CN)

(73) Assignee: GLENFLY TECH CO., LTD. (SHANGHAI), Shanghai (CN)

(21) Appl. No.: 19/448,467

(22) Filed: Jan. 14, 2026

Related U.S. Application Data
(62) Division of application No. 18/441,463, filed on Feb. 14, 2024.

(30) Foreign Application Priority Data
Feb. 14, 2023 (CN) 2023101142742

(51) Int. Cl. H04N 19/89; H04N 19/169; H04N 19/172; H04N 19/174; H04N 19/70; H04N 19/80; H04N 19/91

(52) U.S. Cl. CPC H04N 19/89; H04N 19/172; H04N 19/174; H04N 19/188; H04N 19/70; H04N 19/80; H04N 19/91

(57) ABSTRACT

A control method/system for bit stream parsing error detection in a video hardware decoder including performing a bit stream security range detection on the obtained video stream to obtain a first detection result, performing a bit stream extremum detection on the obtained video stream to obtain a second detection result, an performing an anomaly detection on the process of bit stream parsing on the video stream, and performing an exception handling or a frame reset on the video stream according to the results of the anomaly detection based on the first detection result and the second detection result.

### CROSS-REFERENCE TO RELATED APPLICATION

This is a divisional of U.S. application Ser. No. 18/441,463 filed Feb. 14, 2024, which claims priority from Chinese Patent Application No. 202310114274.2, filed on Feb. 14, 2023, the contents of which is incorporated herein by reference in its entirety.

### FIELD

The present disclosure relates to video decoding; and more particularly, to a video hardware decoder circuit and a control method and a control system for bit stream parsing error detection therein.

### BACKGROUND

With the continuous updates of coding technology in video CODEC (coding and decoding) standards, the efficiency of video coding has been improved. Therefore, the coded video stream has better network affinity, better image quality, and stronger error resistance. At present, video communication has become the main business of communication. However, due to various reasons such as high efficiency compression coding and channel transmission, video streams are prone to errors and data loss during transmission. During hardware decoding, erroneous video streams may cause problems as follows:
1) The hardware decoder cannot recover the correct syntax elements, resulting in decoding errors. Moreover, based on existing decoding technology, forward error codes will be backward diffusion, leading to blurred images in the decoded total video stream;
2) The hardware decoder terminates the entire decoding process incorrectly when decoding some syntax elements with errors, resulting in subsequent video streams being unable to decode;
3) The hardware decoder is unable to handle syntax elements with decoding errors, resulting in an abnormal hardware decoder crash.

Therefore, it is a problem needed to be solved in the design of each decoder that how to find out video stream errors occurred as soon as possible (i.e. video decoder error detection and processing techniques).

When designing existing hardware video decoders, based on the considerations on the complexity of hardware logic and decoding performance, there is almost no detection and processing mechanism for video stream decoding errors added to hardware video decoders. This makes it easy for hardware decoders to experience crashes and blurred decoding images when processing erroneous video streams, as shown in FIG. 1. At present, the main research on hardware decoders in video stream decoding error detection and processing mainly focuses on the following aspects: 1) MB level error detection and control mechanism. For macroblocks with decoding errors, the adjacent macroblocks with correctly decoded, the macroblocks that have completed error processing, or the MV of the macroblocks that have not completed error processing are used to predict the MV of the current processing macroblock. The reference frame pixels of the current frame are used to compensate for motion by using the predicted MV; 2) Frame level error detection and control mechanism, comparing the displayed frame number of the frame to be decoded with the displayed frame number of the most recently displayed frame. If the displayed frame number of the frame to be decoded is smaller than the displayed frame number of the most recently displayed frame, the frame to be decoded will be directly discarded; 3) Detection of network packet loss rate: detecting network packet loss rate and I-frame interval; comparing the network packet loss rate with a preset first threshold to obtain a first comparison result, and comparing the I-frame interval with a preset second threshold to obtain a second comparison result; when an error frame is detected, a preset mode is selected to adjust the error frame based on the first comparison result and the second comparison result, wherein the error frame includes I-frame.

The problems with the above video stream error detection and processing mechanisms as follows:
1) The mechanisms are not suitable for implementation in hardware video decoders. The detection and processing logic of the mechanisms are too complex, which will increase a lot of hardware resources and circuit area. At the same time, complex hardware implementation will reduce the performance of hardware video stream decoding;
2) Video stream error detection is not flexible enough: for example, it can only detect frame level errors, resulting in errors encountered at the slice level still not being handled correctly;
3) The response of video stream error detection processing is too slow: after detecting the error point, it cannot be processed in a timely manner, resulting in hardware decoder crashes;

The image quality after the video stream error processing is too poor: the decoded image shows large areas of blurred images in multi-frame or intra-frame.

### SUMMARY

To achieve the above objectives, the present invention is implemented through the following technical solutions:

Some embodiments provide a control method for bit stream parsing error detection in a video hardware decoder, performed by a computer device, including: performing a bit stream security range detection on the obtained video stream to obtain a first detection result; performing a bit stream extremum detection on the obtained video stream to obtain a second detection result; and performing an anomaly detection on the process of bit stream parsing on the video stream, and performing an exception handling or a frame reset on the video stream according to the results of the anomaly detection based on the first detection result and the second detection result.

Some embodiments provide a control system for bit stream parsing error detection in a video hardware decoder including: at least one memory configured to store program code; and at least one processor configured to read the program code and operate as instructed by the program code, the program code comprising: bit stream security range detection code configured to cause at least one of the at least one processor to perform a bit stream security range detection on the obtained video stream to obtain a first detection result; extremum detection code configured to cause at least one of the at least one processor to perform a bit stream extremum detection on the obtained video stream to obtain a second detection result; and anomaly recognition and reset code configured to cause at least one of the at least one processor to perform an anomaly detection on the process of bit stream parsing on the video stream, and perform an exception handling or a frame reset on the video stream according to the results of the anomaly detection based on the first detection result and the second detection result.

Some embodiments provide a non-transitory computer-readable storage medium storing computer code which, when executed by at least one processor, causes the at least one processor to at least: perform a bit stream security range detection on the obtained video stream to obtain a first detection result; perform a bit stream extremum detection on the obtained video stream to obtain a second detection result; and perform an anomaly detection on the process of bit stream parsing on the video stream, and perform an exception handling or a frame reset on the video stream according to the results of the anomaly detection based on the first detection result and the second detection result.

The video hardware decoder circuit and a control method and a control system for bit stream parsing error detection therein disclosed in the present invention enable the video hardware decoder to have a wider range of error detection for video streams, more flexible detection methods, and higher detection sensitivity. After error processing of the video stream, the decoded video image quality is better, and the impact on the decoding performance of the hardware decoder is smaller.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of a blurred image that occurs after decoded by the video hardware decoder in the prior art;

FIG. 2 is a flowchart of the control method for bit stream parsing error detection in the video hardware decoder according to some embodiments;

FIG. 3 is a specific flowchart of Operation 100 in the control method for bit stream parsing error detection in the video hardware decoder according to some embodiments;

FIG. 4 is a schematic diagram of the occurrence of the bit stream out-of-bounds behaviors during the bit stream security range detection in the control method for bit stream parsing error detection in the video hardware decoder according to some embodiments;

FIG. 5 is a flowchart of Operation 200 in the control method for bit stream parsing error detection in the video hardware decoder according to some embodiments;

FIG. 6 is flowchart of Operation 200 in the control method for bit stream parsing error detection in the video hardware decoder according to some embodiments;

FIG. 7 is a flowchart of Operation 300 in the control method for bit stream parsing error detection in the video hardware decoder according to some embodiments;

FIG. 8 is a schematic diagram of the module of the control system for bit stream parsing error detection in the video hardware decoder according to some embodiments;

FIG. 9 is a schematic diagram of the operation of the bit stream security range detection module in the control system for bit stream parsing error detection in the video hardware decoder according to some embodiments;

FIG. 10 is a schematic diagram of the operation of the extremum detection module in the control system for bit stream parsing error detection in the video hardware decoder according to some embodiments;

FIG. 11 is a schematic diagram of the operation of the extremum detection module in the control system for bit stream parsing error detection in the video hardware decoder according to some embodiments;

FIG. 12 is a schematic diagram of the structure of the video hardware decoder circuit according to some embodiments.

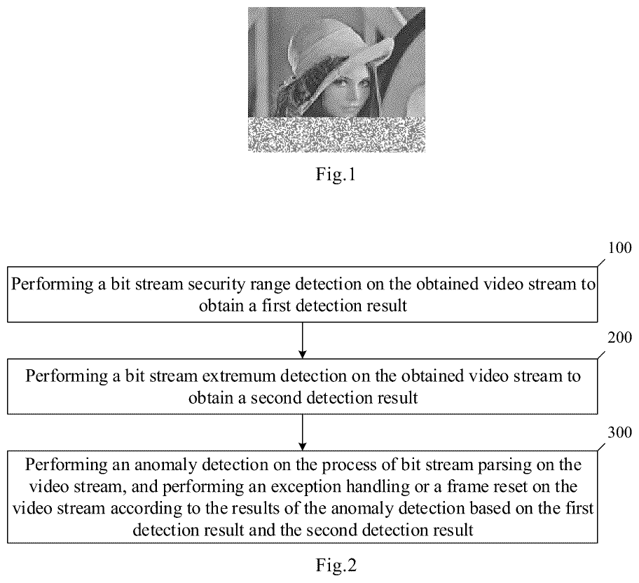

### DETAILED DESCRIPTION

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure and the appended claims.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

One of the purposes of the present invention is to overcome the shortcomings in the prior art, for addressing the technical problems of complex logic, inflexibility, slow response, and poor image quality in video stream error detection and processing mechanisms in the prior art, to provide a video hardware decoder circuit and a control method and a control system for bit stream parsing error detection therein.

Some embodiments provide a control method for bit stream parsing error detection in the video hardware decoder. The method may be performed by a computer device. In this method, the process of an extremum detection is inserted at different stages of the video hardware decoder's operation, and a small number of registers are used to store the results of error detection and exception handling instructions. This enables the video hardware decoder to have error detection and self-healing capabilities at the forefront of bit stream parsing at the slice layer, effectively reducing the interaction between the video hardware decoder and the video processing system when the video hardware decoder is working abnormally, and actively recovering error frames based on the type of error, thereby effectively enhancing the robustness of the video hardware decoder.

Referring to FIG. 2, the method according to some embodiments comprises:
Operation 100: performing a bit stream security range detection on the obtained video stream to obtain a first detection result;
Operation 200: performing a bit stream extremum detection on the obtained video stream to obtain a second detection result;
Operation 300: performing an anomaly detection on the process of bit stream parsing on the video stream, and performing an exception handling or a frame reset on the video stream according to the results of the anomaly detection based on the first detection result and the second detection result.

In some embodiments, in order to address various decoding errors that may occur during the decoding process of video hardware decoders (as described in the background of the invention above), regarding the video stream parsing process under the widely used two video CODEC standards of H.264/H.265, there are three detection mechanisms to enhance the robustness of hardware decoders that different syntax elements have corresponding interval extremum, entropy decoding proposes different extremum detection methods based on the inherent properties of different arithmetic coding methods. In the method of some embodiments, corresponding extremum detection is inserted into the video decoding circuit of the hardware decoder according to the different syntax elements through the operation process from Operation 100 to Operation 300, and by error handling instructions and multiple registers connected with the video decoding circuit, it ensures that the video hardware decoder can correctly identify anomalies in the first time when encountering anomalies. At the same time, because entropy decoding is located upstream in the entire video hardware decoder pipeline, when an anomaly occurs, corresponding error handling instructions are used to notify subsequent hardware modules to decode to the anomaly point and no longer perform conventional decoding. When the video hardware decoder detects an anomaly and broadcasts the anomaly to all modules to complete the reset operation, it will move the data based on the coordinate position of the current anomaly point in the picture, fill the picture of the incorrect coordinate point of the current frame with the corresponding picture of adjacent frames, and end all decoding work of the current frame.

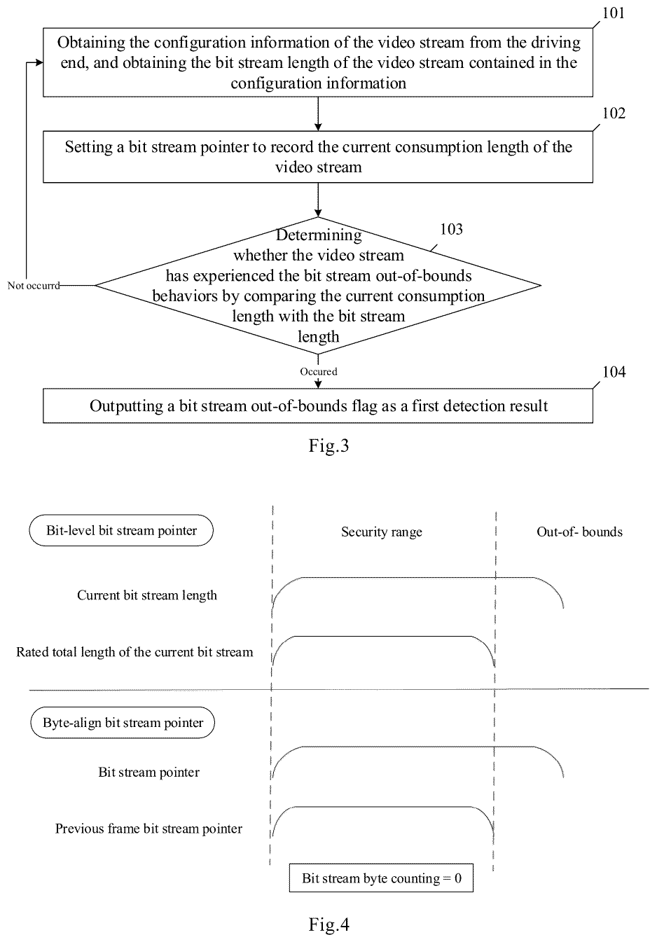

Referring to FIG. 3, in the method of some embodiments, Operation 100 may comprise:
Operation 101: obtaining the configuration information of the video stream from the driving end, and obtaining the bit stream length of the video stream contained in the configuration information;
Operation 102: setting a bit stream pointer to record the current consumption length of the video stream;
Operation 103: determining whether the video stream has experienced the bit stream out-of-bounds behaviors by comparing the current consumption length with the bit stream length; if the determination result is that it has not occurred, returning to Operation 101 to a duplicate determination; if the determination result is that it has occurred, execute Operation 104;
Operation 104: outputting a bit stream out-of-bounds flag as a first detection result.

In some embodiments, the bit stream length of the video stream is used as the header information for frame-level parsing. To obtain this header information during software decoding, the driving end needs to be configured to the video hardware decoder. With the condition of whether the total length of the parsed bit stream length is out of bound, it can be determined whether the current video hardware decoder exceeds the safe parsing range of the bit stream. So, the video decoding circuit can determine whether there is a phenomenon of the bit stream out-of-bounds by adding corresponding bit stream pointers to record the current consumed bit stream length of the video stream compared to the total length. In Operation 102, the bit stream is generally divided into byte-align and non-byte-align. The bit stream pointer (cur_bsb_cmptr) includes two types: byte-align bit stream pointer and bit-level bit stream pointer. Referring to FIG. 4, the byte-align bit stream pointer determines whether the bit stream out-of-bounds behaviors occurs by checking whether the record of the byte counter that counts the byte consumption of the video stream is zero. If the bit stream pointer is a byte-align bit stream pointer, it is necessary to check whether the record of the current byte counter is equal to zero. If the record of the byte counter is zero, it indicates that the current bit stream length of the video stream has been consumed to zero. However, if the length of the current operating byte-align bit stream pointer exceeds the length of the previous frame bit stream pointer (Prv_bsb_cmptr), it indicates that an effective read operation has also occurred, so it is considered that the occurrence of the read bit stream out-of-bounds is decoding abnormal behavior, and the determination result is that it has occurred. And the bit-level bit stream pointer determines whether the bit stream out-of-bounds behaviors has occurred by checking whether the current bit stream length calculated by the bit stream counter is greater than the rated total length of the current bit stream. If the bit stream pointer is a bit-level bit stream pointer, when the current bit stream length (Full_bsb_cmptr) calculated by the byte counter is greater than the rated total length of the current bit stream of the video stream (bsd_cmptr_keep), it indicates that the bit stream decoding has been out of bound, and the determination result is that it has occurred. In the method of this embodiment 1, the video hardware decoder simultaneously uses the above two detection mechanisms to play a dual security role, ensuring that the current bit stream parsing is not out of bound.

Referring to FIG. 5, in the method of some embodiments, Operation 200 may comprise:
Operation 201: obtaining the configuration information of the video stream from the driving end, and obtaining the different syntax elements contained in the configuration information;
Operation 202: obtaining an effective range of the values corresponding to each syntax element according to the bit stream analysis of the syntax elements of the video stream;
Operation 203: determining whether the video stream has experienced the bit stream out-of-bounds behavior by detecting whether the values of each syntax element are within the effective range based on the effective range of the values corresponding to each syntax element; if the value of a syntax element is within the effective range, returning to Operation 201 to a duplicate determination; if the value of a syntax element is outside the effective range, execute Operation 204;
Operation 204: outputting a value out-of-bounds flag as a second detection result.

In some embodiments, take the syntax elements [mb_qp_delta] that need to be bit stream parsed as an example. The position of this syntax element [mb_qp_delta] is within the decoding of the macro block layer, before residual parsing. In bit stream parsing, when the CBF (Coded Block Flag, referring to whether the current block contains non-zero transformation coefficients. If coded block flag=0, the current block does not contain non-zero transformation coefficients. If coded block flag=1, the current block contains at least one non-zero transformation coefficient.) of the current block in the video stream is not zero, or the video stream divides a macro block into an intra-frame mode of 16×16, syntax element parsing [mb_qp_delta] is performed. The meaning of parsing this syntax element [mb_qp_delta] is the increment of the quantization coefficient when the macro block is performing transformation quantization, as shown in table 1 below.

TABLE 1

| if(CodedBlockPatternLuma > 0 \| \| | | |
|---|---|---|
| CodedBlockPatternChroma > 0 \| \| | | |
| MbPartPredMode(mb_type, 0 ) = = Intra_16×16){ | | |
| mb_qp_delta | 2 | se(v)\|ae(v) |
| redisual( ) | 3 \| 4 | |

In some embodiments, a slice decoding starts with the syntax element [slice_qp_delta] as the quantization starting value of the current slice, but when decoding to a certain macro block, the qp value of the current macro block can be rewritten by using the syntax element [mb_qp_delta]. The value of the syntax element [mb_qt-delta] of the current block is defined as [−26+QpBdOffset/2, 25+QpBdOffset/2] according to SPEC (Advanced video coding for general audio services, because H.264 is one of the video encoding technologies named after the H.26x series by ITU-T, it is generally referred to as the H.264 standard), and the final QP value of the current macro block is calculated using the following formula.

$$QP = ( QP + mb\_qp \_delta + 52 + 2 * QpBdOffset ) \% ( 52 + QpBdOffset ) ) - QpBdoffset$$

Through analysis, it was found that the effective range of the syntax element [mb_qp_delta] in video streams is [−26,25]. Because video hardware decoders use unsigned numbers in the process of implementing video decoding, the effective range of the syntax element [mb_qp_delta] is shifted to the right to [0,52]. So the syntax element [mb_qp_detla] is only effective when it falls into this interval, otherwise it is invalid decoding. By adding real-time decoding comparison to the existing video hardware decoder, an error prompt will be given when the value of the syntax element [mb_qp_delta] parsed by the bit stream exceeds this range, allowing the video hardware decoder to obtain effective decoding error information in the first time. The syntax elements similar to the syntax element [mb_qp_delta] include [ref_idx_10], [mvd_10], [coeff_abs_level_minus1], etc., which can be analyzed and obtain the extreme value range of different syntax elements, and effectively determine whether the video hardware decoder is within the safe decoding range.

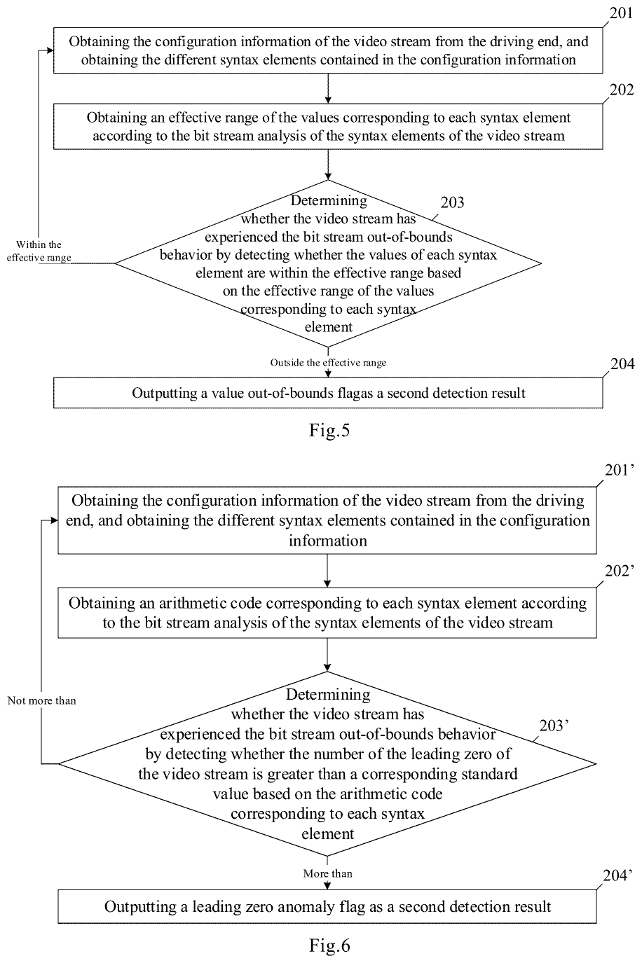

Referring to the FIG. 6, in the method according to some embodiments, Operation 200 can also be performed in the following ways, comprising:
Operation 201′: obtaining the configuration information of the video stream from the driving end, and obtaining the different syntax elements contained in the configuration information;
Operation 202′: obtaining an arithmetic code corresponding to each syntax element according to the bit stream analysis of the syntax elements of the video stream;
Operation 203′: determining whether the video stream has experienced the bit stream out-of-bounds behavior by detecting whether the number of the leading zero of the video stream is greater than a corresponding standard value based on the arithmetic code corresponding to each syntax element; if the number of the leading zero is not more than the corresponding standard value, returning to Operation 201′ to a duplicate determination; if the number of the leading zero is more than the corresponding standard value, execute Operation 204′;
Operation 204′: outputting a leading zero anomaly flag as a second detection result.

In some embodiments, video streams have multiple syntax elements. In the parsing process of video streams, it is possible to determine whether the video hardware decoder is in a normal decoding state based on the inherent properties of different coding modes used by different syntax elements. For example, Exp-Golomb is a widely used coding mode in the H.264 standard. Exp-Golomb coding mainly includes four types: ue(v), se(v), me(v), and te(v), namely unsigned Exp-Golomb coding, signed Exp-Golomb coding, coded Exp-Golomb coding, and truncated Exp-Golomb coding. This application text does not provide a detailed description of each Exp-Golomb coding, only takes the unsigned Exp-Golomb coding as an example for explanation. The explanation of other Exp-Golomb coding can be understood by referring to the unsigned Exp-Golomb coding.

The input value of the unsigned Exp-Golomb is the video stream being parsed, and the output value is the value obtained according to the calculation rule of the unsigned Exp-Golomb based on the current video stream. The calculation rule of the unsigned Exp-Golomb is to start from the current bit and find a value that is not equal to zero, and record the number of zeros already present as the leading zero, which is used as the prefix value. The non-zero values and the values symmetry with the leading zeros are referred to as suffix values, as shown in table 2.

TABLE 2

| Bit string form | The range of codeNum |
|---|---|
| 1 | 0 |
| 0 1 x₀ | 1-2 |
| 0 0 1 x₁ x₀ | 3-6 |
| 0 0 0 1 x₂ x₁ x₀ | 7-14 |
| 0 0 0 0 1 x₃ x₂ x₁ x₀ | 15-30 |
| 0 0 0 0 0 1 x₄ x₃ x₂ x₁ x₀ | 31-62 |
| . . . | . . . |

As shown in table 2 above, the number of leading zeros is consistent in length with the number of valid numerical values. The suffix value is the valid numerical value, and the order of reading from first to last in the video stream is from high to low. Finally, the calculation formula for the codeNum is as follows.

$$codeNum = {2}^{leadingZeroBits} - 1 + read\_bits ( leadingZeroBits )$$

From the above process, it can be seen that the first step in decoding Exp-Golomb is to continuously read out zeros from the video stream until non-zero values appear. Firstly, calculate the number of leading zeros in the video stream. Secondly, select the corresponding standard value based on the type of Exp-Golomb, and then compare the maximum value with the number of leading zeros in the video stream. If the number of leading zeros in the video stream is greater than the corresponding standard value, it indicates a decoding exception and an arithmetic decoding exception flag is outputted to the video hardware decoder. Wherein, the number of seats of leading zeros (leadingZeroBits) is calculated. Through analyzing SPEC regulations, it is found that the definition of Exp-Golomb codeNum is 32 bit unsigned integer, so the effective length of this syntax element in the video stream must be less than or equal to 32. So, if the number of leading zeros of the unsigned Exp-Golomb is greater than 32, it is considered an anomaly. The manner of determination is to first calculate the number of leading zeros, and then determine whether the number of leading zeros is greater than 32. If the number of leading zeros is less than or equal to 32, it is within the safe range, otherwise the Exp-Golomb decoding is anomaly.

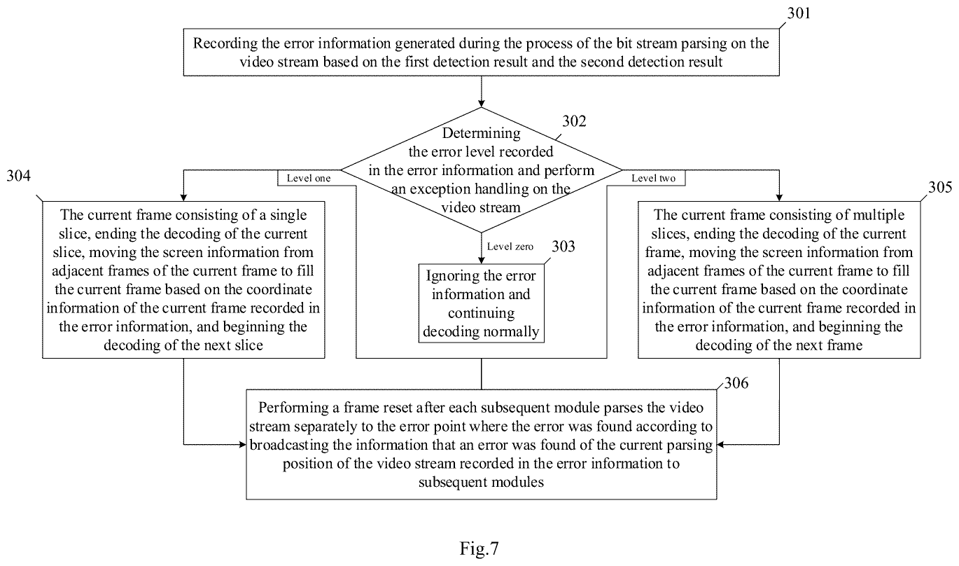

Referring to FIG. 7, in the method of some embodiments, Operation 300 may comprise:
Operation 301: recording the error information generated during the process of the bit stream parsing on the video stream based on the first detection result and the second detection result;
Operation 302: determining the error level recorded in the error information and perform an exception handling on the video stream; when the error level is level zero, execute Operation 303; when the error level is level one, execute Operation 304 and Operation 306; when the error level is level two, execute Operation 305 and Operation 306;
Operation 303: ignoring the error information and continuing decoding normally;
Operation 304: the current frame consisting of a single slice, ending the decoding of the current slice, moving the screen information from adjacent frames of the current frame to fill the current frame based on the coordinate information of the current frame recorded in the error information, and beginning the decoding of the next slice;
Operation 305: the current frame consisting of multiple slices, ending the decoding of the current frame, moving the screen information from adjacent frames of the current frame to fill the current frame based on the coordinate information of the current frame recorded in the error information, and beginning the decoding of the next frame;
Operation 306: performing a frame reset after each subsequent module parses the video stream separately to the error point where the error was found according to broadcasting the information that an error was found of the current parsing position of the video stream recorded in the error information to subsequent modules.

In some embodiments, in the method of this embodiment 1, in addition to constructing a logic for real-time extremum detection and determination during the bit stream parsing process of the video stream, it is also necessary to add exception handling and reset steps in the error detection process of bit stream parsing to handle error situations during the decoding process. In Operation 301, the first detection result obtained from bit stream security range detection will output a bit stream out-of-bounds flag when detecting bit stream out-of-bounds behaviors, and the second detection result obtained from extremum detection will output a value out-of-bounds flag or a leading zero anomaly flag when detecting bit stream out-of-bounds behaviors. As long as one of the flags exists in the first detection result or the second detection result, it will record the error information such as whether any error occurred, error level and type during the current decoding process. In this embodiment 1, two registers and instructions are used to handle the error situation during the decoding process, as shown in tables 3 and 4. The error type register shown in table 3 is used to record the information such as whether any error occurred, error level and type in the current decoding, and the exception handling program register shown in table 4 is used to store an entry address. When an exception occurs, it jumps to the preset exception handling program. In tables 3 and 4, ‘bit’ column represent the positions where values are stored in registers, and the values stored in different positions serve different functions. The position of bit 0 in Table 3 is used to determine whether there is a decoding exception during the video stream parsing process. The positions of bits 1 to 3 are used to determine the error type and the method of exception handling. The positions of bits 4 to 10 are used to record the error type. The positions of bits 11 to 31 are reserved for storing other information for future use. In table 4, the positions of bits 0 to 31 are used for the preset decoding jump destination address when a decoding exception occurs.

TABLE 3

| | Name of error | |
|---|---|---|
| Bit | type | Value of error type in registers |
| [0] | Syntax error | 1′b0: No decoding exception occurred |
| | flag | 1′b1: Decoding exception occurred |
| [3:1] | Error level | 0: Only printing the current error without any |
| | | other behavior occurring |
| | | 1: Jumping to the exception handling program |
| | | and starting the next slice decoding |
| | | 2: Jumping to the exception handling program |
| | | and starting the next frame decoding |
| [10:4] | Error tag | Recording the current different error types |
| [31:11] | Reserved | Reserved bits |

TABLE 4

| | Name of exception | Value of exception handling |
|---|---|---|
| Bit | handling | in registers |
| [31:0] | Branch PC value | preset decoding jump destination |
| | | address |

In Operation 302, when the bit stream out-of-bounds flag, value out-of-bounds flag, or leading zero exception flag is found, it indicates that there is an exception in the bit stream parsing and the level of the error type needs to be determined. The error level can be divided into at least two types. In this embodiment 1, the error level includes level zero, level one, and level two. Different error levels result in different ways of exception handling. In some embodiments, when an exception occurs during the bit stream parsing process, different treatments are taken based on the impact of different errors. The error levels currently used are divided into three types. The first type is level zero. When the error level is level zero, the current error can be ignored, only printing the current error type, ignoring the error information, without any other behavior occurring. The result does not affect continuing normal decoding. According to whether the current frame is a single slice or a multiple slice, it is divided into the second type and the third type. When the current frame is a single slice, it is classified as the second type, which is level one. At this point, it jumps to the exception handling program and ends the decoding of the current slice. When the current frame a multiple slice, it is classified as the third type, which is level two. At this point, it jumps to the exception handling program and ends the decoding of the current frame. This exception handling can be to move the remaining images from the adjacent frames, which have already been parsed, of each frame in the current video stream to fill the current frame based on the coordinate information that has already shown errors in the current video stream. If no bit stream out-of-bounds flag, value out-of-bounds flag, or leading zero exception flag is found, continue normal decoding.

In addition to exception handling when errors occur in bit stream parsing, when the error levels triggered during the bit stream parsing process are level one and level two, a reset operation is performed on the video stream. The function of the reset is to broadcast the information that an error was found from the current bit stream parsing position to subsequent modules. After receiving this signal, due to the execution of the pipeline, subsequent modules may still be parsing the content before the error point. Therefore, when subsequent modules are gradually parsed to the error point, they should be reset. Because the error handling program will now move existing data content for filling, subsequent modules remain idle until the end of the current frame.

Some embodiments provide a control system for bit stream parsing error detection in the video hardware decoder. In this method, the process of an extremum detection is inserted at different stages of the video hardware decoder's operation, and a small number of registers are used to store the results of error detection and exception handling instructions. This enables the video hardware decoder to have error detection and self-healing capabilities at the forefront of bit stream parsing at the slice layer, effectively reducing the interaction between the video hardware decoder and the video processing system when the video hardware decoder is working abnormally, and actively recovering error frames based on the type of error, thereby effectively enhancing the robustness of the video hardware decoder. The control system may include a controller. The controller may include one or more processors and a memory storing computer instructions that are configured to cause, when executed by the one or more processors, the controller to perform its functions.

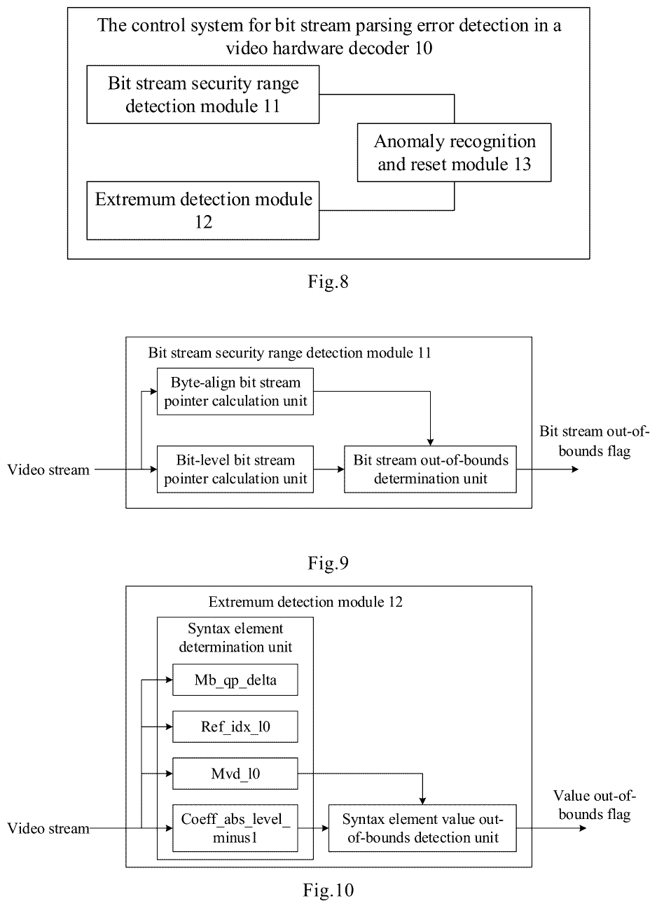

Referring to FIG. 8, the control system for bit stream parsing error detection in a video hardware decoder 10 according to some embodiments comprising: a bit stream security range detection module 11, an extremum detection module 12, and an anomaly recognition and reset module 13, wherein the bit stream security range detection module 11 and the extremum detection module 12 are respectively electrically connected to the anomaly recognition and reset module 13; wherein the bit stream security range detection module 11 is used for performing a bit stream security range detection on the obtained video stream to obtain a first detection result; the extremum detection module 12 is used for performing a bit stream extremum detection on the obtained video stream to obtain a second detection result; the anomaly recognition and reset module 13 is used for performing an anomaly detection on the process of bit stream parsing on the video stream, and performing an exception handling or a frame reset on the video stream according to the results of the anomaly detection based on the first detection result and the second detection result.

In some embodiments, in order to address various decoding errors that may occur during the decoding process of video hardware decoders, regarding the video stream parsing process under the widely used two video CODEC standards of H.264/H.265, there are three detection mechanisms to enhance the robustness of hardware decoders that different syntax elements have corresponding interval extremum, entropy decoding proposes different extremum detection methods based on the inherent properties of different arithmetic coding methods. Corresponding extremum detection is inserted into the video decoding circuit of the hardware decoder according to the different syntax elements through the bit stream security range detection module 11, the extremum detection module 12, and the anomaly recognition and reset module 13, and by error handling instructions and multiple registers connected with the video decoding circuit, it ensures that the video hardware decoder can correctly identify anomalies in the first time when encountering anomalies. At the same time, because entropy decoding is located upstream in the entire video hardware decoder pipeline, when an anomaly occurs, corresponding error handling instructions are used to notify subsequent hardware modules to decode to the anomaly point and no longer perform conventional decoding. When the video hardware decoder detects an anomaly and broadcasts the anomaly to all modules to complete the reset operation, it will move the data based on the coordinate position of the current anomaly point in the picture, fill the picture of the incorrect coordinate point of the current frame with the corresponding picture of adjacent frames, and end all decoding work of the current frame.

Referring to FIG. 9, the bit stream security range detection module 11 includes a byte-align bit stream pointer calculation unit, a bit-level bit stream pointer calculation unit, and a bit stream out-of-bounds determination unit. The byte-align bit stream pointer calculation unit and the bit-level bit stream pointer calculation unit are connected in parallel at the front end of the bit stream out-of-bounds determination unit. When the video stream is inputted into the bit stream security range detection module, the byte-align bit stream pointer calculation unit and the bit-level bit stream calculation unit respectively calculate the length of the bit stream pointer corresponding to the current decoding. The bit stream out-of-bounds detection unit determines whether the length of the current bit stream pointer is out of bound. If it is out of bound, a bit stream out-of-bounds flag is outputted to the video hardware decoder. For the above two types of determination, currently the video hardware decoder simultaneously uses them to play a dual security role, and to ensure that the current bit stream parsing is not out of bound by the two detection mechanisms.

Refer to FIG. 10, the extremum detection module 12 includes a syntax element determination unit and a syntax element value out-of-bounds detection unit. When the video stream is inputted into the extremum detection module 12, the syntax element determination unit parses the bit stream into different syntax elements, and then detects whether its value is out of range through the syntax element value out-of-bounds detection unit. If there is an out-of-bounds exception, a value out-of-bounds flag is outputted to the video hardware decoder.

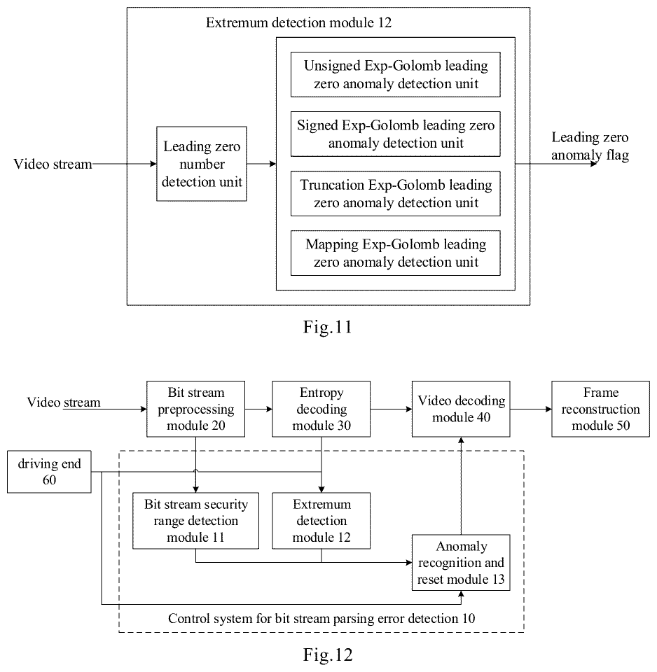

Referring to FIG. 11, the extremum detection module 12 may also include a leading zero number detection unit, an unsigned Exp-Golomb leading zero anomaly detection unit (glomb_ud), a signed Exp-Golomb leading zero anomaly detection unit (glomb_sd), a truncation Exp-Golomb leading zero anomaly detection unit (glomb_td), and a mapping Exp-Golomb leading zero anomaly detection unit (glomb_md), with the unsigned Exp-Golomb leading zero anomaly detection unit (glomb_ud), the signed Exp-Golomb leading zero anomaly detection unit (glomb_sd), the truncation Exp-Golomb leading zero anomaly detection unit (glomb_td), and the mapping Exp-Golomb leading zero anomaly detection unit (glomb_md) connected to the backend of the leading zero number detection unit in parallel. When the video stream is inputted into the extremum detection module, firstly the number of leading zeros in the video stream is calculated through the leading zero number detection unit; secondly, the corresponding standard value is selected through the Exp-Golomb leading zero anomaly detection unit based on the type of Exp-Golomb; then, the maximum value is compared with the number of leading zeros in the video stream. If the number of leading zeros is greater than the corresponding standard value, it indicates a decoding exception and an arithmetic decoding exception flag is outputted to the video hardware decoder.

A person skilled in the art would understand that the above “modules” could be implemented by hardware logic, a processor or processors executing computer software code, or a combination of both. The “modules” may also be implemented in software stored in a memory of a computer or a non-transitory computer-readable medium, where the instructions of each unit are executable by a processor to thereby cause the processor to perform the respective operations of the corresponding unit. In other words, the foregoing modules may be implemented in a form of hardware, or may be implemented in a form of instructions in a form of software, or may be implemented in a form of a combination of software and hardware. Operations in the foregoing method embodiments may be completed by using a hardware integrated logical circuit in the processor, or by using instructions in a form of software. The operations of the methods disclosed with reference to the embodiments may be directly performed and completed by using a hardware decoding processor, or may be performed and completed by using a combination of hardware and software in the decoding processor. In some embodiments, the software may be located in a mature storage medium in the art, such as a random access memory, a flash memory, a read-only memory, a programmable read-only memory, an electrically erasable programmable memory, a register, or the like. The storage medium is located in a memory, and the processor reads information in the memory and completes the steps operations in the foregoing method embodiments in combination with the hardware in the processor.

Some embodiments provide a video hardware decoder circuit, which uses the control system for bit stream parsing error detection in the video hardware decoder disclosed in some embodiments as an additional module in the circuit to execute the control method for bit stream parsing error detection in the video hardware decoder according to some embodiments.

Referring to FIG. 12, the video hardware decoder circuit of some embodiments includes a control system for bit stream parsing error detection 10, a bit stream preprocessing module 20, an entropy decoding module 30, a video decoding module 40, a frame reconstruction module 50, and a driving end 60. Wherein, the bit stream preprocessing module 20 is used for preprocessing the video stream inputted from the network abstraction layer; the entropy decoding module 30 is used for performing entropy decoding on the video stream preprocessed by the bit stream preprocessing module; the video decoding module 40 is used for decoding and filtering the video stream processed by the entropy decoding module; the frame reconstruction module 50 is used for performing frame reconstruction of the video stream processed by the video decoding module; the driver end 60 is electrically connected to the bit stream security range detection module 11, the extremum detection module 12, and the anomaly recognition and reset module 13 in control system for bit stream parsing error detection 10, respectively, to drive the operation of each module; the bit stream security range detection module 11 is electrically connected to the bit stream preprocessing module 20, which is used for performing bit stream security range detection on the obtained video stream to obtain a first detection result; the extremum detection module 12 is electrically connected to the entropy decoding module 30, which is used for performing bit stream extremum detection on the obtained video stream based on different syntax elements parsed from the entropy decoding module 30 to obtain a second detection result.

In some embodiments, after the video hardware decoder circuit is powered on, obtaining configuration information from the driver end, that is, the bit stream length of the current frame decoded by the software is obtained, and storing configuration information the in the error type register as the detection basis of the bit stream security range detection module 11 for the bit stream length; obtaining the extremum of different syntax elements used for range detection of different syntax elements by the extremum detection module 12. In the process of bit stream parsing, there are three detection behaviors. First, the bit stream length from entropy decoding accumulates one by one, if the bit stream consumed length is greater than the total length, it is considered as decoding exception, otherwise as decoding normal. Second, in the case of entropy decoding with an extremum range, the decoded value will be determined based on the initial extremum range, if it is out of bound, it is considered as exception, otherwise as normal; third, in the case of entropy decoding without an extremum value range, the decoded value will be determined based on the coding attribute used, if it is out of bound, it is considered as exception, otherwise as normal. When the bit stream security range detection module 11 and the extremum value detection module 12 detect the video stream and find exceptions, they are processed and reset through the anomaly handling and reset module 13. If the system enables the error correction mechanism, identifying the error type and repairing according to the error type. When the error level is level zero, ignoring the current error; when the error level is level one, it is necessary to skip the current slice; when the error level is level two, it is necessary to skip the current frame. If the system does not enable, ignoring the currently discovered exception.

Some embodiments provide a non-transitory computer-readable storage medium, characterized in that the computer-readable storage medium stores a computer program that, when running on the computer, causes the computer to execute a control method for bit stream parsing error detection in a video hardware decoder as described in some embodiments

Some embodiments provide a computer program product, characterized in that the computer program product comprises a computer program that, when running on a computer, causes the computer to execute a control method for bit stream parsing error detection in a video hardware decoder as described in some embodiments.

The video hardware decoder circuit and a control method and a control system for bit stream parsing error detection therein disclosed in some embodiments enable the video hardware decoder to have a wider range of error detection for video streams, more flexible detection methods, and higher detection sensitivity. After error processing of the video stream, the decoded video image quality is better, and the impact on the decoding performance of the hardware decoder is smaller.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A control method for bit stream parsing error detection in a video hardware decoder, performed by a computer device, comprising:
performing a bit stream security range detection on an obtained video stream to obtain a first detection result;
obtaining configuration information of the obtained video stream from a driving end, and
obtaining different syntax elements contained in the configuration information;
obtaining an arithmetic code corresponding to each syntax element according to a bit stream analysis of the syntax elements of the obtained video stream;
determining whether the obtained video stream has experienced bit stream out-of-bounds behavior by detecting whether a number of a leading zero of the obtained video stream is greater than a corresponding standard value based on the arithmetic code corresponding to each syntax element;
based on the number of the leading zero being not more than the corresponding standard value, returning a duplicate determination;
based on the number of the leading zero being more than the corresponding standard value, outputting a leading zero anomaly flag as a second detection result; and
performing an anomaly detection on a process of bit stream parsing on the obtained video stream, and performing an exception handling or a frame reset on the obtained video stream according to the results of the anomaly detection based on the first detection result and the second detection result.

2. The control method according to claim 1, wherein performing the bit stream security range detection on the obtained video stream comprises:
obtaining the configuration information of the obtained video stream from the driving end, and obtaining a bit stream length of the obtained video stream contained in the configuration information;
setting a bit stream pointer to record a current consumption length of the obtained video stream;
determining whether the obtained video stream has experienced bit stream out-of-bounds behaviors by comparing the current consumption length with the bit stream length;
based on a determination that the obtained video stream has not experienced the bit stream out-of-bounds behaviors, returning a duplicate determination; and
based on a determination that the obtained video stream has experienced the bit stream out-of-bounds behaviors, outputting a bit stream out-of-bounds flag as the first detection result.

3. The control method according to claim 2, wherein the bit stream pointer comprises a byte-align bit stream pointer and a bit-level bit stream pointer;
wherein the byte-align bit stream pointer determines whether the bit stream out-of-bounds behaviors occurs by determining whether a record of the byte counter that counts a byte consumption of the obtained video stream is zero, and based on the record of the byte counter being zero and a length of a current operating byte-align bit stream pointer exceeding the length of a previous frame bit stream, the byte-align bit stream pointer determines that the bit stream out-of-bounds behaviors have occurred; and
wherein the bit-level bit stream pointer determines whether the bit stream out-of-bounds behaviors occurs by determining whether the length of a current bit stream calculated by the bit stream counter is greater than a rated total length of the current bit stream, and based on the length of the current bit stream being greater than the rated total length of the current bit stream, the bit-level bit stream pointer determines that the bit stream out-of-bounds behaviors have occurred.

4. The control method according to claim 1, wherein performing the anomaly detection on the process of bit stream parsing on the obtained video stream, and performing the exception handling or the frame reset on the video stream according to the results of the anomaly detection based on the first detection result and the second detection result comprises:
recording error information generated during the process of the bit stream parsing on the obtained video stream based on the first detection result and the second detection result;
determining an error level recorded in the error information and performing the exception handling on the obtained video stream;
based on the error level being level zero, ignoring the error information and continuing decoding normally;
based on the error level being level one, a current frame consisting of a single slice, ending the decoding of a current slice, moving screen information from adjacent frames of the current frame to fill the current frame based on coordinate information of the current frame recorded in the error information, and beginning the decoding of a next slice;
based on the error level being level two, the current frame consisting of multiple slices, ending the decoding of the current frame, moving the screen information from adjacent frames of the current frame to fill the current frame based on the coordinate information of the current frame recorded in the error information, and beginning the decoding of the next frame; and
performing the frame reset after each subsequent module parses the obtained video stream separately to an error point where an error was found according to broadcasting information that the error was found of a current parsing position of the obtained video stream recorded in the error information to subsequent modules.

5. A control system for bit stream parsing error detection in a video hardware decoder comprising:
at least one memory configured to store program code; and
at least one processor configured to read the program code and operate as instructed by the program code, the program code comprising:
bit stream security range detection code configured to cause at least one of the at least one processor to perform a bit stream security range detection on an obtained video stream to obtain a first detection result;
extremum detection code configured to cause at least one of the at least one processor to:
obtain configuration information of the obtained video stream from a driving end, and obtain different syntax elements contained in the configuration information;
obtain an arithmetic code corresponding to each syntax element according to a bit stream analysis of the syntax elements of the obtained video stream;
determine whether the obtained video stream has experienced bit stream out-of-bounds behavior by detecting whether a number of a leading zero of the obtained video stream is greater than a corresponding standard value based on the arithmetic code corresponding to each syntax element;
based on the number of the leading zero being not more than the corresponding standard value, return a duplicate determination; and
based on the number of the leading zero being more than the corresponding standard value, output a leading zero anomaly flag as a second detection result; and
anomaly recognition and reset code configured to cause at least one of the at least one processor to perform an anomaly detection on a process of bit stream parsing on the video stream, and perform an exception handling or a frame reset on the obtained video stream according to the results of the anomaly detection based on the first detection result and the second detection result.

6. The control system according to claim 5, wherein the bit stream security range detection code is further configured to cause at least one of the at least one processor to:
obtain the configuration information of the obtained video stream from the driving end, and obtain a bit stream length of the obtained video stream contained in the configuration information;
set a bit stream pointer to record a current consumption length of the obtained video stream;
determine whether the obtained video stream has experienced bit stream out-of-bounds behaviors by comparing the current consumption length with the bit stream length;
based on a determination that the obtained video stream has not experienced the bit stream out-of-bounds behaviors, return a duplicate determination; and
based on a determination that the obtained video stream has experienced the bit stream out-of-bounds behaviors, output a bit stream out-of-bounds flag as the first detection result.

7. The control system according to claim 6, wherein the bit stream pointer comprises a byte-align bit stream pointer and a bit-level bit stream pointer;
wherein the byte-align bit stream pointer determines whether the bit stream out-of-bounds behaviors occurs by determining whether a record of the byte counter that counts a byte consumption of the obtained video stream is zero, and based on the record of the byte counter being zero and a length of a current operating byte-align bit stream pointer exceeding the length of a previous frame bit stream, the byte-align bit stream pointer determines that the bit stream out-of-bounds behaviors have occurred; and
wherein the bit-level bit stream pointer determines whether the bit stream out-of-bounds behaviors occurs by determining whether the length of a current bit stream calculated by the bit stream counter is greater than a rated total length of the current bit stream, and based on the length of the current bit stream being greater than the rated total length of the current bit stream, the bit-level bit stream pointer determines that the bit stream out-of-bounds behaviors have occurred.

8. The control system according to claim 5, wherein the anomaly recognition and reset code is further configured to cause at least one of the at least one processor to:
record error information generated during the process of the bit stream parsing on the obtained video stream based on the first detection result and the second detection result;
determine an error level recorded in the error information and perform the exception handling on the obtained video stream;
based on the error level being level zero, ignore the error information and continue decoding normally;
based on the error level being level one, a current frame consisting of a single slice, end the decoding of a current slice, move screen information from adjacent frames of the current frame to fill the current frame based on coordinate information of the current frame recorded in the error information, and begin the decoding of a next slice;
based on the error level being level two, the current frame consisting of multiple slices, end the decoding of the current frame, move the screen information from adjacent frames of the current frame to fill the current frame based on the coordinate information of the current frame recorded in the error information, and begin the decoding of the next frame; and
perform the frame reset after each subsequent module parses the obtained video stream separately to an error point where an error was found according to broadcasting information that the error was found of a current parsing position of the obtained video stream recorded in the error information to subsequent modules.

9. A non-transitory computer-readable storage medium storing computer code which, when executed by at least one processor, causes the at least one processor to at least:
perform a bit stream security range detection on an obtained video stream to obtain a first detection result;
obtain configuration information of the obtained video stream from a driving end, and
obtain different syntax elements contained in the configuration information;
obtain an arithmetic code corresponding to each syntax element according to a bit stream analysis of the syntax elements of the obtained video stream;
determine whether the obtained video stream has experienced bit stream out-of-bounds behavior by detecting whether a number of a leading zero of the obtained video stream is greater than a corresponding standard value based on the arithmetic code corresponding to each syntax element;
based on the number of the leading zero being not more than the corresponding standard value, return a duplicate determination;
based on the number of the leading zero being more than the corresponding standard value, output a leading zero anomaly flag as a second detection result; and
perform an anomaly detection on a process of bit stream parsing on the obtained video stream, and perform an exception handling or a frame reset on the obtained video stream according to the results of the anomaly detection based on the first detection result and the second detection result.

10. The non-transitory computer-readable storage medium according to claim 9, wherein the perform the bit stream security range detection on the obtained video stream comprises:
obtaining the configuration information of the obtained video stream from the driving end, and obtaining a bit stream length of the obtained video stream contained in the configuration information;
setting a bit stream pointer to record a current consumption length of the obtained video stream;
determining whether the obtained video stream has experienced bit stream out-of-bounds behaviors by comparing the current consumption length with the bit stream length;
based on a determination that the obtained video stream has not experienced the bit stream out-of-bounds behaviors, returning a duplicate determination; and
based on a determination that the obtained video stream has experienced the bit stream out-of-bounds behaviors, outputting a bit stream out-of-bounds flag as the first detection result.

11. The non-transitory computer-readable storage medium according to claim 10, wherein the bit stream pointer comprises a byte-align bit stream pointer and a bit-level bit stream pointer;
wherein the byte-align bit stream pointer determines whether the bit stream out-of-bounds behaviors occurs by determining whether a record of the byte counter that counts a byte consumption of the obtained video stream is zero, and based on the record of the byte counter being zero and a length of a current operating byte-align bit stream pointer exceeding the length of a previous frame bit stream, the byte-align bit stream pointer determines that the bit stream out-of-bounds behaviors have occurred; and
wherein the bit-level bit stream pointer determines whether the bit stream out-of-bounds behaviors occurs by determining whether the length of a current bit stream calculated by the bit stream counter is greater than a rated total length of the current bit stream, and based on the length of the current bit stream being greater than the rated total length of the current bit stream, the bit-level bit stream pointer determines that the bit stream out-of-bounds behaviors have occurred.

12. The non-transitory computer-readable storage medium according to claim 9, wherein the perform the anomaly detection on the process of bit stream parsing on the video stream, and the perform the exception handling or the frame reset on the video stream according to the results of the anomaly detection based on the first detection result and the second detection result comprises:
recording error information generated during the process of the bit stream parsing on the obtained video stream based on the first detection result and the second detection result;
determining an error level recorded in the error information and performing the exception handling on the obtained video stream;
based on the error level being level zero, ignoring the error information and continuing decoding normally;
based on the error level being level one, a current frame consisting of a single slice, ending the decoding of a current slice, moving screen information from adjacent frames of the current frame to fill the current frame based on coordinate information of the current frame recorded in the error information, and beginning the decoding of a next slice;
based on the error level being level two, the current frame consisting of multiple slices, ending the decoding of the current frame, moving the screen information from adjacent frames of the current frame to fill the current frame based on the coordinate information of the current frame recorded in the error information, and beginning the decoding of the next frame; and
performing the frame reset after each subsequent module parses the obtained video stream separately to an error point where an error was found according to broadcasting information that the error was found of a current parsing position of the obtained video stream recorded in the error information to subsequent modules.

13. A video hardware decoder circuit comprising:
a bit stream preprocessing module configured to preprocess the video stream inputted from the network abstraction layer;
an entropy decoding module configured to perform entropy decoding on the video stream preprocessed by the bit stream preprocessing module;
a video decoding module configured to decode and filter the video stream processed by the entropy decoding module;
a frame reconstruction module configured to perform frame reconstruction of the video stream processed by the video decoding module; and
a driving end and the control system for bit stream parsing error detection as claimed in claim 5.
